(19) United States
(12) Patent Application Publication
(10) Pub. No.: US 2026/0298289 A1
(43) Pub. Date: Oct. 1, 2026

(54) BUSHING AND METHOD FOR PRODUCING A BUSHING

(71) Applicant: SKF MARINE GMBH, Hamburg (DE)

(72) Inventor: Jonas CHUN, Hamburg (DE)

(21) Appl. No.: 19/569,008

(22) Filed: Mar. 17, 2026

(30) Foreign Application Priority Data
Mar. 25, 2025 (DE) 102025111397.1

(51) Int. Cl. F16C 33/14; B22F 10/22; B33Y 10/00; B33Y 80/00

(52) U.S. Cl. CPC F16C 33/14; B33Y 80/00; B22F 10/22; B33Y 10/00

(57) ABSTRACT

A method for producing a bushing includes forming a cylindrical shell on an upper surface of an annular support by additive manufacturing. The annular support has an upper surface, a central opening, and a central longitudinal axis, and the cylindrical shell is formed from successively applied layers of melted metal and has a shell longitudinal axis colinear with the central longitudinal axis of the annular support. Forming the cylindrical shell may include forming an annular base on the annular support and forming a cylindrical shell main body on an upper surface of the annular base. The annular base may have a radial width greater than a radial thickness of the cylindrical shell main body.

### CROSS-REFERENCE

This application claims priority to German patent application no. 10 2025 111 397.1 filed on Mar. 25, 2025, the contents of which are fully incorporated herein by reference.

### TECHNOLOGICAL FIELD

The disclosure relates to a method of producing a bushing and a bushing produced by the method.

### BACKGROUND

Bushings are used to reduce friction between elements which move relative to one another, for example, elements of machines in a very wide range of applications, such as in vehicles, power plants or manufacturing plants. They are designed to be mounted on at least one component of the respective apparatus and to guide or secure a rotatable shaft or axle or a displacement component (e.g. a rod or a pipe) that is to be moved axially (linearly). To this end, the bushings must each have an internal diameter matching the diameter of the shaft or axle or displacement component. Depending on size, intended use and intended properties, different materials are used to produce bushings.

Metal bushings are usually made by casting a molten material into respective suitably sized casting molds.

### SUMMARY

An aspect of the present disclosure is to enable improved production of metal bushings.

A method according to the present disclosure is used to produce a bushing. Here, a shell of the bushing is additively constructed of successively melted metal (for example, a metal wire or a metal powder) on an annular support and around its central axis.

In particular, the shell is gradually lengthened in the axial direction in order to construct it. The terms “axial” and (further below) “radial” always refer in this document to a central axis of the annular support (around which the annular support runs in a non-rotationally symmetrical or rotationally symmetrical or rotary-symmetrical manner), which preferably coincides with a central axis of the shell.

The shell can be of non-rotationally symmetrical or rotationally symmetrical or rotary-symmetrical, in particular circular-cylindrical, design. Preferably, it is constructed with a uniform wall thickness.

The construction by additive manufacturing eliminates the need for suitable casting molds for the respective bushing sizes (in particular, diameters of shafts or axles or displacement components) and thus means a high degree of variability in the production of a very wide variety of bushings with one and the same manufacturing plant. Additive manufacturing also prevents the formation of defects in the shell. In addition, a respective bushing can be produced with little effort with particularly thin walls and quickly according to a particular need, such that the spatially and logistically demanding storage of a very wide variety of bushings in order to ensure a respective availability can be dispensed with; instead, only the metal (that is to say possibly, e.g., the metal wire or the metal powder) and the annular support must be held in stock. Finally, a bushing produced in this way as well as a bushing produced in the casting process can be easily repaired by additive melting, if necessary.

A bushing according to the disclosure comprises an annular support and a metal shell connected to the annular support (for example, melted onto, adhesively bonded to or welded onto it) and running around its central axis. The shell can be designed, in particular, in a circular-cylindrical manner. Preferably, it has a uniform (measured in the radial direction) thickness (i.e. wall thickness). According to advantageous embodiments, the shell of a bushing according to the disclosure is additively made of a successively melted metal. In particular, the bushing according to the disclosure can be produced by one embodiment of the method according to the disclosure.

The bushing produced according to the disclosure or the bushing according to the disclosure can be, in particular, a stern tube bushing of a watercraft or a bushing for a seal (which can likewise belong to a watercraft).

The annular support can preferably comprise a part formed as an annular washer in a method according to the disclosure or in a bushing according to the disclosure (in particular, formed overall as an annular washer). Their surfaces lying opposite one another then preferably lie in respective planes extending orthogonally relative to the central axis.

In the radial direction, the annular support of a bushing according to the disclosure can protrude inwards and/or outwards from the shell; analogously, the shell can be constructed in a method according to the disclosure in such a way that the annular support protrudes radially inwards and/or outwards from it. In particular, the bushing can thus be formed as a flange bushing, the collar of which is at least partly formed by the annular support.

The annular support can be at least partially made of metal; this metal can be identical to or different from that metal from which the shell is constructed.

According to advantageous embodiments of the method according to the disclosure (preferably in a continuous construction process with the additive construction of the shell), a flange is also formed additively from the metal, which protrudes inwardly and/or outwardly from the shell and is connected to a surface, extending radially with respect to the central axis, of the annular support, and preferably bears against this surface. A flange arranged in this way is also referred to below as the “bottom surface flange” in order to distinguish it from other flanges. It affords the advantage of a particularly durable connection between the shell and the annular support. A bushing according to the disclosure preferably has a bottom surface flange formed monolithically with the shell.

In such embodiments, the bottom surface flange can have, at least in regions, a thickness (measured in the axial direction) which is smaller than a thickness (radially measured, uniform or average) of the shell. This enables material savings and a particularly simple formation of the bushing, wherein a high stability is nevertheless ensured due to the annular support connected to the bottom surface flange.

In embodiments in which a bottom surface flange protrudes radially inwards from the shell, it can preferably reach as far as a radially inner bounding edge of the annular support, in particular it can likewise extend radially inwards as far as the annular support. As a result of the resulting utilization of the surface area of the annular support, the shell and the annular support can be connected to each other in this manner in a particularly solid manner by means of the bottom surface flange; in addition, the inner bounding edge of the annular support and the inner edge of the bottom surface flange can together form a reinforced guide for a shaft, axle or displacement component to be passed through.

According to advantageous embodiments of the method according to the disclosure, (preferably in a continuous construction process with the additive construction of the shell), in addition, one or more flanges are formed additively from the metal, which is/are spaced apart in the axial direction from the annular support with respect to the central axis (i.e., are/is at a distance from the annular support, which is greater than zero), and projects/project here radially inwards and/or outwards from the shell. Flanges arranged in this way are referred to below as “overhang flanges”. At least one inwardly projecting overhang flange can serve, in particular, for guidance for a shaft, axle or rod to be passed through and can avoid contact thereof with the shell here, such that a particularly low friction occurs in use without the shell having to be smoothed on the inside; this means a considerable reduction in the production cost. A bushing according to the disclosure can accordingly have at least one such overhang flange, which can then preferably be formed monolithically with the shell.

According to a further aspect of the disclosure, a method for producing a bushing includes forming a cylindrical shell on an upper surface of an annular support by additive construction. The annular support has an upper surface, a central opening, and a central longitudinal axis, and the cylindrical shell comprises successively applied layers of melted metal and a shell longitudinal axis colinear with the central longitudinal axis of the annular support. Furthermore, forming the cylindrical shell may include forming an annular base on the annular support and forming a cylindrical shell main body on an upper surface of the annular base. The annular base may have a radial width greater than a radial thickness of the cylindrical shell main body, and a radial inner wall of the cylindrical shell main body may be located radially outward of a radially inner edge of the annular base such that a portion of the annular base radially inward of the radially inner wall of the cylindrical shell main body forms a bottom surface flange.

Embodiments of the present disclosure are advantageous, in particular, in which at least one such overhang flange likewise protrudes radially inwards from the shell as far as the annular support. The overhang flange and the inner bounding edge of the annular support can thus together form a guide for a shaft, axle or rod to be passed through.

### BRIEF DESCRIPTION OF THE DRAWINGS

Preferred exemplary embodiments of the disclosure will be explained in greater detail in the following text on the basis of drawings. It goes without saying that individual elements and features can also be combined and/or configured differently from what is shown.

FIG. 1A is an axial sectional view of a bushing formed by an exemplary embodiment of a method according to the disclosure.

FIG. 1B is an axial sectional view of a bushing formed by a conventional method.

### DETAILED DESCRIPTION

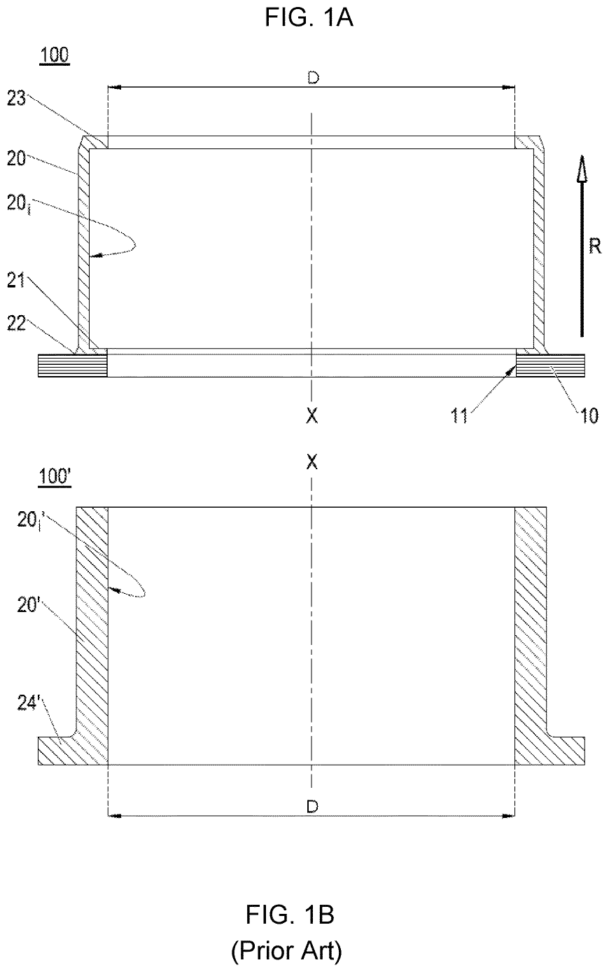

FIG. 1A shows a bushing 100 produced by an exemplary embodiment of the method according to the disclosure, and thus, in particular, a bushing 100 according to the disclosure having an annular support 10, as an annular washer formed around a central axis X, and a shell 20 surrounding the central axis X. In particular, the central axis X of the annular support 10 corresponds to the central axis of the (preferably circular-cylindrical) shell 20. FIG. 1A shows the bushing in a sectional view along this axis X.

The shell 20 was constructed in a manner following an axial construction direction R, additively from successively melted metal (for example metal wire or metal powder) on the annular support 10 and around its central axis X with a constant or uniform wall thickness (i.e. thickness measured in the radial direction).

The bushing 100 further comprises a bottom surface flange 21, which is connected to, for example, is melted onto, a surface, extending radially with respect to the central axis X, of the annular support 10. In the exemplary embodiment shown, the bottom surface flange 21 likewise extends radially inwards as far as an inner opening of the annular support 10, to the radially inner bounding edge 11 of which the bottom surface flange thus reaches. Its thickness (measured in the axial direction) is smaller than the thickness of the shell 20 measured in the radial direction. The bottom surface flange 21 may be described as an annular base (of the cylindrical shell) on which a cylindrical shell main body (of the cylindrical shell) is formed.

A stabilizing projection 22 which projects radially outwardly and is likewise connected to the annular support 10 serves, in the exemplary embodiment shown in FIG. 1A, for further strengthening of the connection of the shell 20 and support 10.

At the end axially opposite the annular support 10, the bushing 100 has an overhang flange 23, which likewise extends radially inwards from the shell as far as the annular support 10 and the bottom surface flange 21. As a result, a diameter D is defined, which a shaft, axle or displacement component (not shown) to be guided through the bushing 100 can have; in addition, it is ensured that such a shaft, axle or displacement component does not bear against a radially inner surface 20i of the shell 20. Thus, no friction occurs on the surface 20i, which is why it also does not have to be reworked, in particular smoothed, in order to improve tribological properties.

The annular support 10 protrudes radially outwards beyond the shell 20 (and beyond the stabilizing projection 22); in particular, the bushing 100 is formed as a flange bushing, the collar of which is formed by the annular support 10.

FIG. 1B shows, in contrast, a bushing 100′ produced according to a conventional manufacturing method, in particular cast in a suitable casting mold, in a sectional view along its central axis X.

The bushing 100′ is of monolithic design and comprises a shell 20′, onto which a flange 24′ is molded. In particular, the bushing 100′ is likewise (that is to say, like the bushing 100 shown in FIG. 1A) formed as a flange bushing and is designed for leading through a shaft, axle or displacement component (not shown) with a diameter D. In contrast to the bushing 100 according to the present disclosure, contact of the shaft, axle or displacement component is provided with the inner wall 20′i of the shell 20′, which therefore must be reworked, in particular smoothed, after casting in order to reduce frictional resistance.

As can be further seen from a comparison of FIGS. 1A and 1B, the production according to the method according to the disclosure, in comparison with a conventional method, allows the generation of a reduced shell thickness (thickness of the shell measured in the radial direction), which means a weight and material saving.

A method for producing a bushing 100 is disclosed, in which method a shell 20 of the bushing 100 is additively constructed of successively melted metal on an annular support 10 and around its central axis X.

Further disclosed is a bushing 100 having an annular support 10 and a metal shell 20 connected to the former and extending around a central axis X of the annular support.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bushings and methods for forming bushings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

List of Reference Signs

| | |
|---|---|
| 10 | Annular support |
| 11 | Radially inner bounding edge |
| 20, 20′ | Shell |
| 20i, 20′i | Inner wall of the shell |
| 21 | Bottom surface flange |
| 22 | Stabilizing projection |
| 23 | Overhang flange |
| 24′ | Flange |
| 100, 100′ | Bushing |
| D | Diameter of a shaft, axle or displacement |
| | component to be guided through |
| R | Construction direction |
| X | Central axis |

What is claimed is:

1. A method for producing a bushing, the method comprising:
forming a cylindrical shell on an upper surface of an annular support by additive manufacturing,
wherein the annular support has an upper surface, a central opening, and a central longitudinal axis, and
wherein the cylindrical shell comprises successively applied layers of melted metal and a shell longitudinal axis colinear with the central longitudinal axis of the annular support.

2. The method according to claim 1,
wherein forming the cylindrical shell comprises forming an annular base on the annular support and forming a cylindrical shell main body on an upper surface of the annular base,
wherein the annular base has a radial width greater than a radial thickness of the cylindrical shell main body, and
wherein a radial inner wall of the cylindrical shell main body is located radially outward of a radially inner edge of the annular base such that a portion of the annular base radially inward of the radially inner wall of the cylindrical shell main body forms a bottom surface flange.

3. The method according to claim 2,
wherein a radially inner edge of the bottom surface flange is located at an edge of the central opening of the annular support.

4. The method according to claim 3,
wherein an axial thickness of the bottom surface flange is less than a radial thickness of the cylindrical shell main body.

5. The method according to claim 4,
wherein a radial outer wall of the cylindrical shell main body is located radially inward of a radially outer edge of the annular base such that a portion of the annular base radially outward of the radially outer wall of the cylindrical shell main body forms a stabilizing projection.

6. The method according to claim 5,
including forming a second flange at an end of the cylindrical shell body at a location axially spaced from the annular base.

7. The method according to claim 6,
wherein the second flange has an inner edge lying on same imaginary cylinder as the central opening of the annular support.

8. A bushing comprising an annular support and an additively manufactured metal shell extending from the annular support, wherein the annular support and the metal shell have a same central longitudinal axis.
